(19) United States
(12) Patent Application Publication
(10) Pub. No.: US 2014/0052545 A1
(43) Pub. Date: Feb. 20, 2014

(54) METHOD AND APPARATUS FOR PRODUCING AND FINANCING MEDIA PRODUCTIONS

(71) Applicant: John E. DeTitta, Rochester, NY (US)

(72) Inventor: John E. DeTitta, Rochester, NY (US)

(21) Appl. No.: 14/015,567

(22) Filed: Aug. 30, 2013

Related U.S. Application Data
(63) Continuation of application No. 11/274,706, filed on Nov. 14, 2005.
(60) Provisional application No. 60/626,933, filed on Nov. 12, 2004.

(51) Int. Cl. G06Q 40/06; G06Q 30/02

(52) U.S. Cl. CPC G06Q 40/06; G06Q 30/0273
USPC 705/14.69

(57) ABSTRACT

In one embodiment, a method of producing and financing a media production comprises the steps of selecting a media production to be produced, developing a budget for the production costs of the selected media production, and developing a marketing plan comprised of a plurality of advertising buys having a set of advertising materials targeted toward a corresponding one of a plurality of advertisers. The subject matter of a selected media production relates to the interests of at least one of the plurality of advertisers. Revenue from the completed advertising buy is collected and the selected revenue produced by the completed advertising buy is placed into a media production fund.

This invention is a continuation of U.S. patent application Ser. No. 11/274,706 filed on Nov. 14, 2005 and is related to Provisional Patent Application Ser. No. 60/626,933, entitled “AdFilmTies Film Financing Process” filed on Nov. 12, 2004, and is incorporated herein by reference.

### FIELD OF THE INVENTION

The present invention relates generally to media financing and more specifically it relates to such a process that allows advertisers to finance media productions through advertising media buys while eliminating the risk of normal event financing speculative investment.

### BACKGROUND OF THE INVENTION

The movie industry comprises of a process in which a film is created by media producers and then shown to the general public in movie theatres across the world. The process begins with a screenplay; this is the creative thoughts of an individual put down into words, of what they see being made into a film. An individual takes their thoughts placing them on a document and begins to write a screenplay.

The standard length of a screenplay for an independent feature film is 120 pages typed in courier font and double spaced. The screenwriter creates characters in the screenplay that hold the interest of a viewer. The characters go through a process of conflict and solution within the pages of the screenplay.

Upon completion of the screenplay, the screenwriters now are left with the challenge of turning their words into a financed film. A screenwriter at first would seek an agent. An Agent is an individual who is familiar with the financing of the film industry and has contacts with other individuals in the industry, and presents screenplays to these individuals for a percentage of the sale. An agent usually receives a 10% fee of the sale of the screenplay.

After, an agent will seek an interest from a producer or movie studio. A movie studio is a company whose job it is to seek screenplay's that they believe would produce revenue from a film's audience once produced. A movie studio has the means to finance, produce and distribute a finished film. The producer is an individual who knows the film business and has contacts with individuals who can assist in the financing of the screenplay into a film production. If a producer takes on the screenplay, the producer begins to raise funds for the financing of the screenplay.

The independent film community comprises of a vast number of screenplays, producers, actors and directors all seeking to have their creative ideas financed and made into an independent film. This is highly charged extremely competitive marketplace. There are many screenplays and a limited amount of film financing available.

The film community over the years has relied on three consistent methods of financing these projects. The first and most common is a producer who would seek a screenplay that he/she would like to see made into a production. After careful review of the screenplay, the producer determines if the screenplay has potential, that when financed and produced will be viewed by users or consumers who would pay for tickets to see it in a move theatre.

If a producer believes that the screenplay has film potential, he/she would then get an option of ownership on the script, allowing the producer to purchase it under specified terms if financed. Upon securing the rights to the screenplay, the producer would then determine a production budget sufficient to turn the screenplay to a film.

After completion of a budget, it is the job of the producer to raise the necessary funds required by the budget. Traditionally, the producer is limited to three main sources of funds. The first and most relevant in the film industry is to seek investors who would own a percentage of the film and subsequent profits from the film in return for their investment.

A commitment of a respected producer to produce a particular screenplay would generally be to increase the value of the screenplay to investors by securing talent or attachments to the screenplay. To do this, a producer would present the screenplay to producers, actors and directors who would see the value of the screenplay and become attached to the project. Attachment is a means by which an actor, a producer or a director states that if the film is financed, they would be the director or actor in the film. Sometimes they are paid or guaranteed revenue for this attachment even if the film budget is not raised.

With the increased value of the screenplay due to the attachments, the producer would continue to seek investor funding based on the potential of the project. If the producer can convince enough investors to raise the funds of the budget of the project, they can begin production of the film.

The second way a producer can seek funding is to pre-sell the screenplay to a sales agency. A sales agency or distributor is someone who based on the screenplay and/or any attachments, sees the value of the project and will pay revenue to the producer to film the project in exchange for the sale rights of the project as it is distributed into the movie theatres.

A distributor or sales agent might buy the rights to the project for a specific country, foreign distribution or outright sale of the project. This would all be determined by the producer and the distributor.

The main problem with current film finance is that it is extremely speculative for the investors. The standard rate of success is that 2 out of every 10 movies produced actually make money for its investors. In addition, due to the extremely competitive industry, the number of investors is small, and the choices for them are many.

A process that screenwriters and/or the film community could use to eliminate the risk to investors in films or other media productions would expand the availability of revenue and would be of tremendous value to the media industry.

It can be appreciated as described above that traditional methods of film financing have been in use for years. Typically, film financing involves speculative investments through sales of interest in ownership of the film.

The main problem with conventional film financing is that the investor has a high chance of losing their investment. Another problem with conventional film financing is that the speculative investment gives limited if any public relations to the investor. Another problem with conventional media event financing is that it is difficult for the film producer to get a film financed.

While some forms of financing may be suitable for the particular purpose to which they are used, they are not as suitable to allow advertisers to finance film productions while eliminating the risk of normal film financing speculative investment. The main problem with conventional film financing methods is the investor as a high chance of losing its investment. Another problem is the speculative investment gives limited if any public relations to the investor. Also, yet another problem is that it is difficult for the event producer to get an event financed.

### SUMMARY OF THE INVENTION

Therefore, it is an object of the present invention to provide a media financing process that will overcome the shortcomings of the prior art processes and devices.

A further object of the present invention is to provide a media production financing process for advertisers to finance film productions while eliminating the risk of normal film financing speculative investment.

A still further object is to provide a media production financing process that allows the financing of media productions without the speculative risk of present film financing processes.

Another object is to provide a media production process that generates revenue through advertising that benefits the user or consumer.

A still further object is to provide a media production financing process that creates awareness and education of Mental Health disorders, Health disorders, and other topics that benefit people in a way that is financed by the consumer impressions.

Another object is to provide a media event financing process that allows many media event producers to get their productions financed.

A still further object is to provide a media event financing process that creates the ability for the advertisers to receive the added value of public relations, product placement, branded entertainment, and brand awareness as provided by the distribution and viewing by the public of the media productions.

Other objects and advantages of the present invention will become obvious to the reader and it is intended that these objects and advantages are within the scope of the present invention.

In accordance with these and other objects of the invention, this invention provides a method of producing and financing a media event. This method comprises the steps of selecting a media event to be produced and developing a budget for the production costs of the selected media event, and developing a marketing plan which is comprised of a plurality of advertising buys, each of the plurality of advertising buys being targeted toward a corresponding one of a plurality of advertisers. Further, there is disclosed a set of advertising materials that are targeted toward to a corresponding one of the plurality of advertisers. The subject matter of a selected media event relates to the interests of at least one of the plurality of advertisers, the cost of developing the marketing plan and the set of advertising materials not exceeding the developed budget. The next step presents to at least one of the plurality of advertisers the cost of the budget and the advertising material of at least one of the plurality of advertising buys. Each of the plurality of advertising buys requires a predetermined number of impressions to be completed. Further if the at least one advertising buyer purchases the at least one advertising buy, the advertising materials are produced and placed on a media property. For at least one of the plurality of advertising buys, the number of impressions to which at least one user is exposed on the on media property are counted, thereby completing the one advertising buy when the counted number of impressions equals its buy's predetermined number of impressions. Finally, the revenue from the completed advertising buy is collected and the revenue produced by the completed advertising buy is placed into a media production fund.

In a further aspect of this invention, the media property is selected from a group comprising a website, newspaper, telephone directory, radio or television.

In another aspect of this invention, the media event is selected from a group comprising a motion picture, a television program, a radio program, a concert and recording of an event.

In a still further aspect of this invention each of the advertising materials is selected from a group comprising the internet banner advertisement, the print advertisement, the radio advertisement or the television advertisement.

In another aspect of this invention, the event is presented to produce added value advertising selected from the group comprising product placement, public relations, branded entertainment and other movie related associations all included in the standard media buy.

### DESCRIPTION OF THE DRAWING FIGURES

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1, is a functional block diagram illustrating how a user's browser and a server of the website to be accessed by the user's browser are connected to and by a communication link to each other; and

FIG. 2, is a flow diagram of the process of producing and financing media productions in accordance with the teaching of this invention.

### DETAILED DESCRIPTION OF A PREFERRED EMBODIMENT

The financing process of this invention is programmed to receive guaranteed impressions for media buys while having their advertising dollars continue on to the media event fund that is used to create the media productions. A media outlet that provides educational and/or entertaining content channels dealing with relevant subject matter. The media outlet is designed to generate impressions and/or consumers who are seeking help and education or entertainment with specific content. The consumers who seek education and come to the media outlet produce an advertising commodity by creating impressions that are sold to advertisers. A media outlet includes but not limited to film, Television, Print, Internet (and a corresponding web site), Yellow Pages and other means as would be well known to those skilled in the art. The user is playing a part in the creation of a media production by simply visiting and/or viewing the media outlet and getting content information. As will be explained in detail below, an impression is counted each time a user is exposed to a screen carrying certain advertising material. The impressions created by the consumer are sold as a commodity to the advertiser who is seeking targeted advertising to these consumers. The net revenue created by the advertiser is placed in an event fund and this event fund creates film productions dealing with the subject matter of preference to the advertiser. Since the advertiser has received dollar for dollar advertising there is no risk involved in the financing of the media production and the advertiser receives the added value of the public relations and involvement of the media production. The community ties created by the visitor and the media production financing process allows the community to be educated on issues involving mental health, health and other beneficial causes by the distribution and public viewing of the media production.

The media outlet provides content of interest to the target audience. The media outlet is designed to generate impressions and/or consumers who are seeking help, education or entertainment with specific content or interest to the advertisers. For example, the media outlet can be internet based, radio, television or print that has educational and/or entertaining content dealing with the specific subject matter.

The user, who seeks education, can access the media outlet to provide an advertising commodity by creating impressions that are sold to advertisers. The consumer is playing a part in the creation of media productions by simply visiting the media outlet and getting content information. The user is the individual who will come to the media outlet to view the content provided on its channels. The user may be an individual who is seeking entertainment and/or education on one or more of the media outlets.

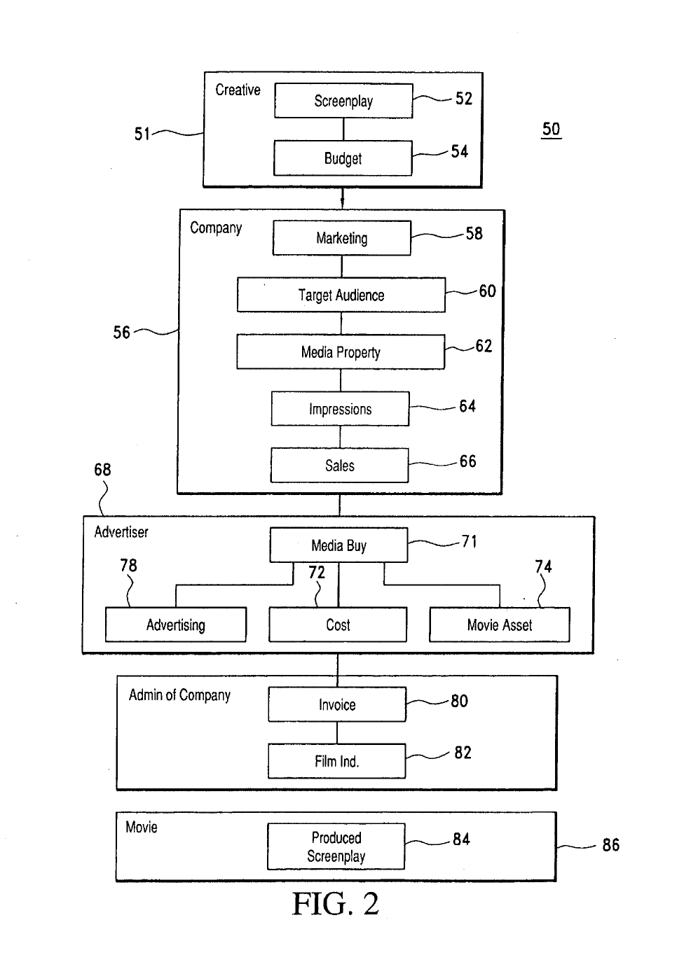

The impressions created by the user may also be sold to an advertiser who is seeking targeted advertising to these kinds of users. An advertiser is an individual or company who benefits by paying revenue to have advertising materials promoting a particular business placed on the specific media outlet. An advertiser is targeting the attention of the user who is viewing a specific content channel of the media. In an illustrated example of this financing process 50 as will be explained below in greater detail with respect to FIG. 2, the advertisers sell or market products to the users or customers who are viewing the content of the media outlet. The advertiser sells or markets a product or service to the users who visit the media outlet. In particular, the advertisers benefit from the public relations created by the advertising materials displayed at the media outlet.

The net revenue earned by the advertiser is placed in a production fund and this fund is used to construct the media production dealing with the subject matter of preference to the advertiser. Since the advertiser has received benefit from the web advertising that is equal to the value of the fees input into the production fund, there is no risk involved in the financing of the film production and, further, the advertiser has also received the added value of distributing the media production to the defined audience. A story is told through the media production that is broken down into characters, scenes and is performed by actors before a video camera or film camera. The recorded scenes are then broken into an editing process and a final production is created to be viewed before an audience to promote a particular cause and to simulate one form of emotion or another.

The creation and financing of media productions in accordance with this invention allow the community to be educated on issues involving Mental Health, Health and other Life issues. For example, the financing process of this invention begins with a media outlet that provides the advertising materials that generates impressions from the user who is seeking information on a specific content channel within the media outlet. The impressions created by the consumer are then sold to the advertiser who is interested in targeting a particular user with products or services and the revenue that is created by the advertiser is placed into the media production fund that produces media productions dealing with the content subject matter of interest.

A media producer that wants to finance a media production dealing with a specific subject matter can advertise on the media outlet to the consumers who view the content and subject matter. The advertiser would receive and be able to sell the media standard advertising impressions to produce revenue, which would also be included in the media production fund. The advertiser has purchased advertising at cost and therefore has received a value equal to the advertiser's investment. The advertiser's investment is then placed into the media production fund that creates a film financed by the advertiser's media buy at no financial risk to the advertiser.

The method of financing a media production in accordance with this invention allows an entity to finance these projects through advertising revenue. The process begins with a screenplay being created and company's producers seeking screenplays that have potential for profits. Once a screenplay is identified by a producer, the producer then creates a budget for the production of the screenplay. Once the budget is created, the media producer provides the screenplay along with the budget to an entity or company, which has administration, marketing and sales functions. The administration verifies the budget, and provides the approved product to a marketing team. The marketing team reviews the screenplay, the defined target audience and demographics of the defined audience.

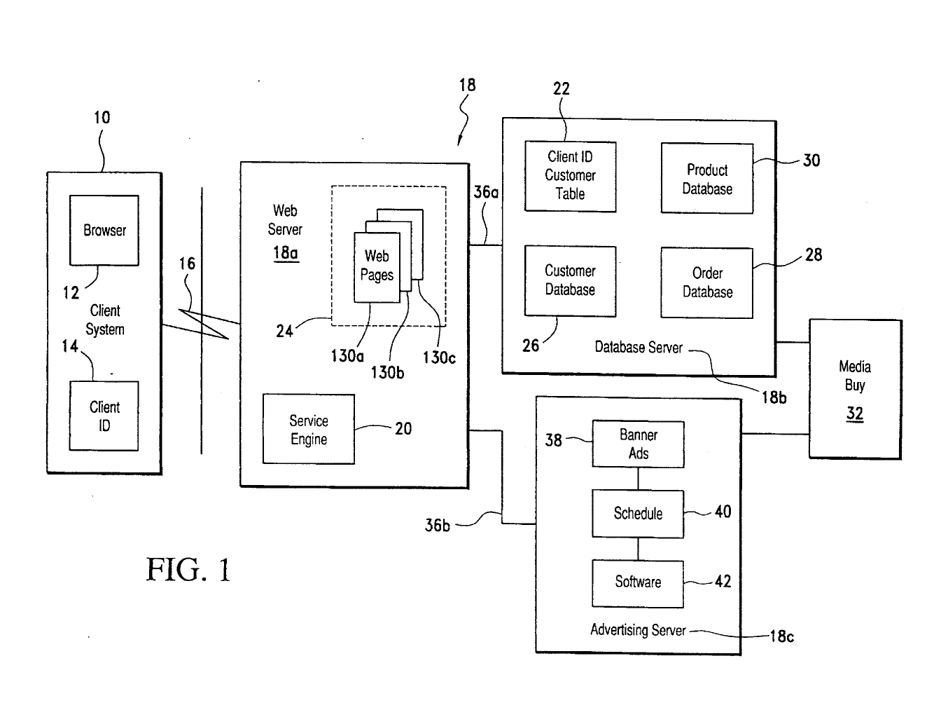

Referring now to the drawings and in particular to FIG. 1, there is shown an embodiment of this invention which permits a browser or user, using his/her client system 10 to access a server system 18 by exchanging messages over a communication link 16. In one illustrative embodiment of this invention, it may take the form of the Internet. The client system 10 comprises of a browser 12 and its assigned client identifier, which is known as a “cookie”. The client identifier is stored in a file 14. Though only a single client system 10 is illustrated in FIG. 1, it will be appreciate that there would typically be a plurality of client systems 10, which are connected by a communications link 16 to the server system 18. In one illustrative embodiment of this invention, the user initiates on the browser 12 a communications session with the server system 18 by assigning and sending over the link 16 his/her client identifier to the client system 18. From then on, the client system 10 includes its client identifier with all messages sent to the server system 18 so that the server system 18 can identify the particular client system 10 from which the message was sent.

The server system 18 comprises, as shown in FIG. 1, a web server 18a, a data base server 18b and an advertising server 18c. The server system 18 is front ended as described above, in that the user can access the system 18 by sending requests from the browser 12 via the communication link 16 to the web server 18a. The advertising server 18 is programmed to regulate the advertisements to be seen by the users. This can be done by storing the advertisement materials in the form of acceptable internet standards, i.e. banner ads, pop-ups, text ads and rich media, in corresponding databases 38, 40 and 42. The advertising server 18c is programmed to run the ads based on predetermined impressions, length of contract with the advertiser. This data is back ended, i.e. this data is input to the server system 18 via a media buy block 32.

The internet comprises a vast number of computers and computer networks that are interconnected through communication links such as the link 16 as shown in FIG. 1. The interconnected computers exchange information using various services, such as electronic mail, Gorpher, and the World Wide Web (“WWW”). The WWW service allows a server computer system (i.e., Web server or Web site) to send graphical Web pages or screens of information such as the advertising materials to a remote client computer system 10. The remote client computer system 10 can then display the Web pages. Each resource (e.g., computer or Web page) of the WWW is uniquely identifiable by a Uniform resource Locator (“URL”). To view a specific Web page in a request (e.g. a HyperText Transfer Protocol (“HTTP”) request). The request is forwarded to the Web server 18a that supports that Web page 18a when the Web server 18a receives the request; it sends that Web page to the client computer system 10. When the client computer system 10 receives that Web page, it typically displays the Web page using the browser 12. The browser 12 is a special-purpose application program that effects the requesting of Web pages and the displaying of Web pages.

Currently, Web pages are typically defined using Hyper-Text Markup Language (“HTML”). HTML provides a standard set of tags that define how a Web page is to be displayed. When a user indicates to the browser 12 to display a Web page, the browser sends a request to the server computer system an HTML document that defines the Web page. When the requested HTML Document is received by the client computer system, the browser 12 displays the Web page or screen.

The World Wide Web is especially adapted to conducting electronic commerce and advertising. In an illustrated embodiment of this invention, the primary focus is on the advertising of the internet, which is a 5 billion dollar per quarter industry.

Advertising on the internet is created by and through the media property and content on the web property. The web property is marketed to a target audience who visits the web property to view the content provided. Every time an individual visits the web property, he/she creates an impression.

Referring now to FIG. 2, there is shown a preferred embodiment of the media production financing system 50 in accordance with the teachings of this invention. FIG. 2 shows the invention flow from a creative process 51 to the finished financed production media. The financing process 50 begins with the creative process 51, wherein the producer, who is defined as the manager of the development of the media production, seeks in step 52 to identify a screenplay to produce. Upon selecting of a screenplay that the producer feels would be well received in the marketplace, the producer constructs in step 54 a screenplay development budget for producing the screenplay into a media production, which may illustratively take the form of a film. The screenplay production budget defines the costs to take the screenplay and make it into the media production.

Once a budget is completed, the producer presents the finished creative process 51 to the company. The company is the owner or a licensee of the creative process. In an illustrative embodiment of this invention, the company has internal divisions to administer the creative process. A marketing department for example evaluates in step 58 the screenplay and determines in step 60 a target audience of potential viewers. The target audience includes a demographic, which comprises the age, sex and interests of that audience that would view the finished media production. For example as set forth in our current usage, we have included a site 130, which creates a demographic of individuals who would be interested in the movie industry and, therefore, a target audience for the advertisers within a community of targeted users. It also attracts a demographic of individuals in the 16-35 year range. Upon determining a target audience, the marketing team creates in step 62 a media property and then promotes it to attract potential targeted audience to access and view the media property. The media property comprises a description of the relevant target audience and the content carried by the media that could illustratively take the form of print, radio, television or as defined above in this financial media production process 50. When the media property is created in step 62, the marketing team begins to attract visitors to the media property creating impressions in step 64.

Ad Impression is defined by the Internet advertising bureau as the standard in internet advertising as a measurement of responses from an ad delivery system to an ad request from the user's browser 14, which is filtered from robotic activity and is recorded at a point as late as possible in the process of delivery of the advertising materials to the user's browser—therefore the closest to actual opportunity to see by the user.

In particular, an impression is a visitor to the website through access to the World Wide Web that visits a screen of the media property. These impressions create a commodity in the advertising community and are packaged by the sales team to be sold in step 66 to an advertiser.

The advertiser is an individual or company, which generally sells in step 68 a product or service, desires to market its self to the targeted audience and purchases the targeted impressions from the sales team at a predetermined media buy. A media buy defines a predetermined cost per impression, and the length of the contracts and ads to be displayed on the media property. The advertiser determines in step 72 the cost of the impressions and in step 78 creates and places the advertising materials on a screen of the media project. In the course of the financial process 50, the advertiser receives in step 71 additional added value benefits pre-determined in the media buy. These benefits result from the distribution in step 74 of the film and include movie association resulting from product placement, film interaction, branded entertainment, public relations value or other additional benefits to advertiser.

The media buy is then fulfilled by the company, as the terms of the media buy are completed. Once the media buy has been completed, the company will invoice in step 80 the advertiser for the cost of the media buy. The advertiser in step 82 now pays the invoice and the company takes the revenue generated and places it into the media production fund. The production fund in one illustrative embodiment is a bank account managed by the company. The fund then provides in step 84 the necessary funding to the producer as specified in his/her production development budget. The producer then uses these funds to finance the development of the screenplay into a finished production media.

Two methods are used to deliver ad content to the user—server-initiated and client-initiated. Server initiated ad counting uses the site's web content server 18a for making requests, formatting and re-directing content. Client-initiated ad counting relies on the user's browser 12 to perform these activities (in this case the term “client” refers to an internet user's browser 12). The standard method is a client-initiated approach of which the reference process 50 and for the sake of this description relies upon.

A valid impression may only be counted when an ad counter receives and responds to an HTTP request for a tracking asset from a client. The count must happen after the initiation of retrieval of underlying page content. Permissible implementation techniques include (but are not limited to) HTTP request generated by <IMG>, <FRAME>, or <SCRIPT SRC>. For client-side ad serving, the ad content itself could be treated as the tracking asset and the ad server itself could do the ad counting.

The response by the ad counter includes but is not limited to: Delivery of a “beacon”, which may be defined as any piece of content designation as a tracking asset. Beacons commonly are in the form of 1×1 pixel image. Delivery of a “302” redirector or html/JavaScript (which doubles as a tracking asset) to any location, and delivery of ad content.

Measurement of any ad delivery may be accomplished by measuring the delivery of a tracking asset associated with the ad. The ad counter must employ standard header on the response, in order to minimize the potential of caching.

Each of these impressions has a value to them based on the audience and the value to the advertiser. Once a media property is created and visitors come to the media property site and there is a sufficient number of impressions to market the users to advertisers.

On the internet, the impression cost is based on guaranteeing/providing to the user on per thousand impressions or CPM. The average cost to the advertiser is 15$ per thousand impressions. A sales team of the company then markets the impressions on the website to the advertiser for a set number of impressions and cost in a media buy. A media buy sets the terms and cost of the advertising provided by the media property to the advertiser.

The media production finance process 50 then sells sufficient advertising to advertisers on the media property to obtain enough revenue for the cost of the budget provided by the producer. If the advertiser receives a standard media buy however, the funds generated from the media buy is placed into the media production fund that subsequently financed the media production.

Although the present invention has been described in terms of various embodiments, it is not intended that the invention be limited to these embodiments. Modification within the spirit of the invention will be apparent to those skilled in the art. The scope of the present invention is defined by the claims that follow.

What is claimed is:

1. A method of raising funds for a project, said method comprising the steps of:
a) providing a webpage for said project and determining a target fund amount for the project;
b) providing a plurality of advertising buy options having respective media outlets available for purchase by an advertiser accessing said project webpage;
c) upon an advertiser purchasing a selected one or more media buy, causing the advertisers advertising material to be placed on the media properties associated with the purchased media buys; and
d) collecting the revenue from the completed advertising buy and applying the selected revenue produced by the completed advertising buy to said target fund.

2. The method of claim 1 wherein said project is a media production.
